(19) United States
(12) Patent Application Publication
(10) Pub. No.: US 2015/0279195 A1
(43) Pub. Date: Oct. 1, 2015

(54) METHOD FOR PREVENTING CHILDREN BEING LEFT IN CAR BY USING OBD2 SOCKET AND SMARTPHONE

(71) Applicant: DAVY ZIDE QIAN, ARCADIA, CA (US)

(72) Inventor: DAVY ZIDE QIAN, ARCADIA, CA (US)

(21) Appl. No.: 14/230,019

(22) Filed: Mar. 31, 2014

(51) Int. Cl. G08B 21/24; G08B 21/02

(52) U.S. Cl. CPC G08B 21/24; G08B 21/0277

(57) ABSTRACT

A method for preventing children from being left in a car. The method comprises find an OBD2 socket in a car; insert an OBD2 adapter with bluetooth in the OBD2 socket; equip a driver with a smartphone having a reminder program; use the Bluetooth to establish communication between the OBD2 adapter and the smartphone; when the OBD2 adapter obtains car moving information from the OBD2 socket, the moving information is sent to the smartphone by the Bluetooth; AND the reminder program issues order to operate the smartphone to make a reminder to the driver, let the driver take necessary response to prevent children being let in car.

### CROSS REFERENCE TO RELATED PATENT APPLICATION

The present application claims the priorities of U.S. provisional applications No. 61806964 filed on Apr. 1, 2013 and No. 61843034 filed on Jul. 4, 2013, which applications are incorporated herein by reference.

### FIELD OF THE INVENTION

This invention belongs to an electronic communication field. More practically, this invention relates to an area of electronic alarm device.

### BACKGROUND OF THE INVENTION

It is dangerous to leave children alone in a locked car, and especially in the summer or winter. That many children have died from heat stroke, hypothermia or suffocation in hot (or freezing) cars has caused tragedies in many families. Most of those tragedies were not caused intentionally by the acts of parents or drivers with children, but by their negligence and forgetfulness. Sometimes, a parent brought a kid out to shop, and the kid fell into a sleep in the car, the busy parent rushed to go to shopping since a lot of housework was waiting for him or her, and forgot the kid(s) who were sleeping in the cars. The parent locked the car, and as a result, caused a great misfortune, the kid suffocated and died in the extremely hot and locked car. The parent had to take legal responsibilities for the act that he or she caused. In some cases, those parents not only lost their kids, but also ruined their families.

People wish to have a driver alarm for preventing children from being left in the car. The driver's alarm should automatically remind the parent/driver about having kids inside the car when leaving the car; therefore, such tragedies can be avoided. Thus, the driver alarm for preventing children being locked inside of a car is very important.

Some of these kinds of inventions were made before; however no one is seen in the market. The Main reason is these inventions are complicated, and especially, too complicated to install; thus cannot be adopted by the public. For those reasons, it is important to invent a method for preventing children being left in a car and a device thereof, which is simple to use and reliable.

### SUMMARY OF THE INVENTION

A method for preventing children being left in car comprising:

find an OBD2 socket in a car;

insert an OBD2 adapter with bluetooth in the OBD2 socket;

equip a driver with a smartphone having a reminder program;

use the Bluetooth to establish communication between the OBD2 adapter and the smartphone;

when the OBD2 adapter obtains car moving information from the OBD2 socket, the moving information is sent to the smartphone by the Bluetooth;

the reminder program issues order to operate the smartphone to make a reminder to the driver, let the driver take necessary response to prevent children being let in car.

Further, the car moving information is TPOD of trigger point of departure, or TPOA of trigger point of arrival.

Further, the TPOD is determined by change of revolution per minute from “0” to above “0”, the TPOA can be determined by the change of revolution per minute from above “0” dropping down to “0”.

Further, the order of reminder program is that when receiving TPOD the program orders smartphone to issue reminder regarding that the car is stated and the driver completes things must do, when receiving TPOA the program orders smartphone to issue reminder regarding the car is stopped and the driver completes things must do.

Further, the driver operates the smartphone to response the reminder issued by the smartphone.

### DETAIL DESCRIPTION OF PREFERRED EMBODIMENTS

The inventor discover many patent applications relating to the device alarm for preventing children from being left in car. However to date there are no this kind of device is sold in market. Main reason is that some devices are very complex in assembly with car. Other reason is that some device is simple but its work is not reliable.

The purpose of present invention is to find a simple and reliable method to prevent children from being left in car. The other purpose is to design a simple and reliable warning device to prevent children from being left in car. The new feature of present invention which is different from existed prior art is to combine driver's judgment if have children in car with a reminder device to realize the purpose of invention described above. A method and a device for preventing children being left in car achieved in this way are simple and reliable.

In this new embodiment, we are using the information from the OBD2 (On-Board Diagnostics II, or any past or future versions of it) on any modern vehicles as a means to measure and retrieve car battery voltage information or any other information/parameters to detect and determine the status of the car or its engine/motor if it's an electric car or a hybrid car.

With this new embodiment, instead of getting inserted into the car cigarette lighter socket, our new device (which has at least all the functionalities of our original device as detailed in previous patent applications) can be connected/inserted into the OBD2 socket/jacket inside of a car, so we can gather information and detect/determine, through OBD2, whether the engine/motor is getting started which associates to the Trigger Point Of Departure (TPOD) indicating the driver is getting ready to start the trip and drive away, or the engine/motor is being turned off which associates to the Trigger Point Of Arrival (TPOA) indicating the driver has finished his trip and reached his destination and is getting ready to leave the car behind.

The TPOD can also be associated with inserting a car key into the key hole, or pushing of the “start button” on some newer cars; and the TPOA can also be associated with pulling out of the car key from the key hole, or pushing of some button (while the engine/motor is running) to turn it off.

Of course, there can be other ways based upon the information that is available through OBD2 to detect/determine the timing of the TPOD (Trigger Point Of Departure) and the TPOA (Trigger Point Of Arrival).

At the TPOD (Trigger Point Of Departure), our new device can issue a verbal question to ask the driver if there is a baby on board (similar to our original device) and the driver can respond by pushing a red button or a green button, just like in our original version of the device.

Our new device will then register the driver's response for the Status Of Baby Occupancy (SOBO) the lack of a response after certain seconds defaults to a positive SOBO (Status Of Baby Occupancy) to be more conservative.

And then at the TPOA (Trigger Point Of Arrival), based upon the registered SOBO (Status Of Baby Occupancy), the new device will issue a warning sound/prompt to remind the driver not to leave the baby behind just like our original device would do. In addition, given the prevalence of newer smart cell phones (Android, iPhone, or BlackBerry) and the wide usage of Bluetooth communication nowadays, our new device can also be equipped with a Bluetooth adaptor to communicate with a Smart cell phone installed with an appropriate “App” so that at the TPOD the speaker on the Smartphone will be directed to issue the verbal question about the status of baby occupancy (SOBO), the driver can then answer either “yes” or “no” to the Smartphone, and then the status of baby occupancy (SOBO) can be transmitted from the smart phone to our new device and get registered by our new device, to be used later when the TPOA occurs.

Finally, the followings are for the more generalized use of the method itself per se; although with smart phones, it's a lot easier to implement.

The concepts and notions of the TPOD (Trigger Point Of Departure) and TPOA (Trigger Point Of Arrival) and SOBO (Status Of Baby Occupancy)and the verbal question(s) at the TPOD about occupancy status, as well as the final reminder at the TPOA can all be generalized and find more general usages:

SOBO can be replaced by occupancy status of anything important not to be left behind inside the car at the end of a trip, such as perishable items like meat, milk, ice-cream, etc . . . so the verbal question(s) at the TPOD may need to be more general, and the final reminder/prompt at the TPOA can also be more general so that the driver will be reminded to take his groceries inside the house instead of leaving them in the car trunk under the sun on a hot summer day. Actually, with a more general question(s) at the TPOD, the drivers can also be reminded not to leave important and necessary items behind before departing from home for an example, such as house keys, cell phones, phone-chargers, backpack, suitcase, passports, air tickets, money, etc.

What we are disclosing in this application is that when determining TPOD (Trigger Point Of Departure) or TPOA (Trigger Point Of Arrival) based on OBD2 information output:

1. The TPOD can be determined by the change of rpm (revolution per minute) from “0”(zero) to above “0”, amongst other parameters;

2. The TPOA can be determined by the change of rpm from above “0” dropping down to “0”, amongst other parameters;

3. The user can use a smart phone with any operating system such as iOS, or Android that has Bluetooth connection which can connect with the Bluetooth equipped OBD2 adapter via Bluetooth.

4. For the situation when a driver has to leave the car momentarily for a very short time while fully aware he or she has to return to the car quickly to attend to the baby inside of the car under a very hot weather (e.g. the driver leaves the car to go to some convenience store for a very short period of time while being fully aware that the baby is still inside the car and he or she has to return to the car quickly), we designed the following extra feature mobile App with the following extra functions of the device: This extra “Periodical Alarm” feature that this said smart phone App has for this situation is that after the TPOA occurs with the SOBO (Status Of Baby Occupancy)being positive, the App will make sounds from the smart phone to remind the driver to bring the baby with him/her just like what are described in our earlier applications; But it also gives the driver a reminder and option (of leaving the baby inside the car while keeping the engine and air conditioner running this Periodical Alarm feature is independent of the engine's on/off status) to bring the smart phone with him/her and turn the Periodical Alarm feature on to make alarming beeps or verbal prompts such as “Your baby is still in the car” to sound periodically (e.g. every 10 seconds) on the smart phone until the driver deems the periodical reminder is no longer needed when the driver goes back to the car (he can push a button on the smart phone screen which can be programmed to disable the Periodical Alarm), or until the child is removed from the car and the Periodical Alarm feature can be disabled for that particular trip.

This Periodical Alarm feature is designed so that if it is not acknowledged for 3 times in a row by not pushing a button on the smart phone screen when prompted, then it will dial a pre-designated emergency contact phone number and report the situation by a prerecorded voice message and geo-tag with GPS location/coordinates information; or if that phone call is not answered and acknowledged by receiving a feedback of pushing some certain digits (such as 1234), it will call local 911, or both one after another—to be safer.

5. Under the same circumstances (driver having to leave the car momentarily for a short period of time) as above, but if the driver does NOT want to turn off the engine (hence NOT triggering TPOA) in order to keep the air conditioning up and running inside the car to keep it cool for the occupants, the App can provide an option for the driver to turn on the Periodical Alarm manually by him/her self—if the driver does remember to turn it on until the driver later deems it can be disabled;

6. Under the same circumstances (driver having to leave the car momentarily for a short period of time) as above but without engine being turned off in order to power the air conditioner (hence not triggering TPOA).

In this case of driver forgetting to turn on the Periodical Alarm manually: The App will constantly monitor the change of rpm; the App will also constantly monitor the Bluetooth connection between the smart phone and the Bluetooth equipped OBD2 adaptor. As a matter of fact this App needs to monitor the rpm and Bluetooth constantly no matter what.

If the Bluetooth connection is lost (after TPOD occurred but before TPOA occurs), that means the smart phone is taken away from the car by the driver most likely; This new App will then activate the Periodical Alarm feature.

If the smart phone has Bluetooth connection with the Bluetooth equipped OBD2 adaptor and detects the rpm is above zero and remains “basically constant” (or changes within a small range), this will indicate the car is not moving but the engine is just running to keep the air conditioner (AC) going to cool the inside of the car. If this goes on beyond a set amount of time (e.g. 60 seconds), then this may indicate the baby is being left inside the car alone without the driver being there; the App will then activate the Periodical Alarm feature at this point.

What is claimed is:

1. A method for preventing children being left in car comprising:
find an OBD2 socket in a car;
insert an OBD2 adapter with bluetooth in the OBD2 socket;
equip a driver with a smartphone having a reminder program;
use the Bluetooth to establish communication between the OBD2 adapter and the smartphone;
when the OBD2 adapter obtains car moving information from the OBD2 socket, the moving information is sent to the smartphone by the Bluetooth;
the reminder program issues order to operate the smartphone to make a reminder to the driver, let the driver take necessary response to prevent children being let in car.

2. The method of claim 1, wherein the car moving information is TPOD of trigger point of departure, or TPOA of trigger point of arrival.

3. The method of claim 2, wherein the TPOD is determined by change of revolution per minute from “0” to above “0”, the TPOA can be determined by the change of revolution per minute from above “0” dropping down to “0”.

4. The method of claim 2, wherein the order of reminder program is that when receiving TPOD the program orders smartphone to issue reminder regarding that the car is stated and the driver completes things must do, when receiving TPOA the program orders smartphone to issue reminder regarding the car is stopped and the driver completes things must do.

5. The method of claim 1 wherein the driver operates the smartphone to response the reminder issued by the smartphone.

6. The method of claim 2 wherein after the TPOA occurs with the SOBO (Status Of Baby Occupancy)being positive, the smart phone reminds the driver to bring the baby with him/her; the smart phone also gives the driver a periodical alarm program to make alarming beeps or verbal prompting to sound periodically on the smart phone, when the driver goes back to the car he can disable the periodical alarm program.

7. The method of claim 6 wherein the periodical alarm program is designed so that if it is not acknowledged for designed times after prompting then it will dial a pre-designated emergency contact phone number and report the situation by a prerecorded voice message and geo-tag with GPS location/coordinates information.
